(19) United States
(12) Patent Application Publication
(10) Pub. No.: US 2011/0149705 A1
(43) Pub. Date: Jun. 23, 2011

(54) Data storage in optical discs

(75) Inventors: Richard H. Selinfreund, Clinton, CT (US); Rakesh Vig, Durham, CT (US); Jeffrey M. Drew, Darien, CT (US); Donald Roland Goyette, Plainfield, CT (US)

(73) Assignee: Verification Technologies, Inc., Essex, CT (US)

(21) Appl. No.: 11/659,654

(22) PCT Filed: Sep. 7, 2005
(86) PCT No.: PCT/US05/31639

§ 371 Date: Nov. 1, 2007

Related U.S. Application Data
(63) Continuation-in-part of application No. 10/939,281, filed on Sep. 10, 2004, now abandoned.
Application No. 10/939,281 is a continuation-in-part of application No. 09/608,886, filed on Jun. 30, 2000, now abandoned.

(51) Int. Cl. G11B 27/36; G11B 7/24

(52) U.S. Cl. 369/53.21; 369/275.5; G9B/7

(57) ABSTRACT

A device for preventing and controlling copying of data from an optical storage disc utilizing physical modifications in or on a storage capable optical disc. Also described is, a method for authenticating and controlling reading or copying of information or data in or on optical discs as, for example, wherein a locus on or in the optical storage disc is initially read to produce a signal and is then re-read by a reader to produce a second signal. The signal detected upon re-reading is different from the signal that is detected upon initial sampling.

### CROSS-REFERENCE

This application claims benefit of U.S. patent application Ser. No. 10/939,281, filed Sep. 10, 2004, which is a continuation-in-part of application Ser. No. 09/608,886, filed Jun. 30, 2000, abandoned, the contents of which are incorporated by reference herein in their entirety.

### FIELD OF THE INVENTION

The present invention is directed to copy protection of optical recording discs and specifically to the protection of the data recorded on optical discs.

### BACKGROUND OF THE INVENTION

Optically readable digital storage discs, such as music and software CD's and video DVD's, provide inexpensive ways to share and disseminate digital information, making such disc the disc of choice among both producers and consumers. This is clearly evident as CD's have nearly replaced cassette tapes and floppy discs in the music and software industries and DVD's have made significant in roads in replacing video cassette tapes in the home video industry. Because of the high demand for such optical disc and because of the ease and low cost of reproduction, counterfeiting has become prevalent.

A variety of copy protection techniques and devices have been developed to limit the unauthorized copying of optical discs. Among these techniques are analog Colorstripe Protection System (CPS), CGMS, Content Scrambling System (CSS) and Digital Copy Protection System (DCPS).

Analog CPS (also known as Macrovision) provides a method for protecting videotapes as well as DVDs. The implementation of Analog CPS, however, may require the installation of circuitry in every player used to read the disc. Typically, when a disk or tape is “Macrovision Protected,” the electronic circuit sends a colorburst signal to the composite video and s-video outputs of the player resulting in imperfect copies. The use of Macrovision may also adversely affect normal playback quality.

With CGMS, the disc may contain information dictating whether or not the contents of the disc can be copied. The device that is being used to copy the disc must be equipped to recognize the CGMS signal and also must respect the signal in order to prevent copying.

The Content Scrambling System (CSS) may provide an encryption technique that is designed to prevent direct, bit-to-bit copying. Each disc player that incorporates CSS is provided with one of four hundred keys that allow the player to read the data on the disc but prevents the copying of the keys needed to decrypt the data. However, the CSS algorithm has been broken and has been disseminated over the Internet, allowing unscrupulous copyists to produce copies of encrypted discs.

The Digital Copy Protection System (DCPS) provides a method whereby devices that are capable of copying digital disc may only copy discs that are marked as copyable. Thus, the disc itself may be designated as uncopyable, however, for the system to be useful, the copying device must include the software that respects the “no copy” designation.

Each of these copy protection techniques, and others that may be available, may make it more difficult to copy material from optical disc, and may deter the casual copyist. However, these techniques may be easily circumvented by the unscrupulous copyist who is intent on making digital copies of an optical disc.

### SUMMARY OF THE INVENTION

In one illustrative embodiment, a method of authenticating stored data on or in optical discs is disclosed. A locus on an optical storage disc is read and a first set of data is received from the locus. The locus is then re-read and a second set of data is read from the locus the second set of data being different from the first set of data.

In another illustrative embodiment an optical disc is disclosed. The optical disc includes a substrate and a data track disposed on the substrate. A light-sensitive compound is disposed on or in at least a portion of the disc and cooperates with the data track to alter the data upon excitation with a suitable stimulus.

In another illustrative embodiment, a method of treating an optical storage disc is disclosed. Data is recorded onto the optical storage disc and a light-sensitive compound is applied to the disc. At least a portion of the light-sensitive compound is selectively activated.

In another illustrative embodiment an optical recording disc is disclosed. The optical recording disc includes stored data and means for altering, upon re-reading, data that is read from a locus on the disc.

In another illustrative embodiment, an optical recording disc is disclosed. The disc includes a data track involving readable data. At least a portion of the output is altered predictably upon re-reading.

In another illustrative embodiment, a method of authenticating an optical storage disc is disclosed. The disc has a first plane including data and a second plane having a light-sensitive compound. The method includes reading data from the first plane, exciting the light-sensitive compound in a second plane and reading data from the second plane.

As another illustrative embodiment, a method for authenticating stored information in or on an optical disc involves reading the optical disc at a locus to obtain data true to the series of bits represented by the optical data structure at such locus; re-reading the optical disc at the locus to determine if the data obtained varies by one or more bits in the series of bits represented by the optical data structure at such locus; and authenticating the stored optical information on or in the disc if the data obtained in the re-reading step differs from the initial reading data.

As a more specific illustrative embodiment, the method further provides the means of prohibiting reading of the series of bits represented by said optical data structure, or portion thereof, if the information stored in or on the optical disc is not authenticated.

As another illustrative embodiment, the method also provides reading at a first locus combined with re-reading the optical disc at a second locus.

According to one illustrative embodiment, the data obtained in the initial reading step produces a signal that is inadequate to provide for an intended use of data stored on the disc, while the data obtained in the re-reading step produces a signal that is adequate to provide for an intended use of data stored on the disc.

According another illustrative embodiment of the method, the data obtained in the initial reading of the optical storage capable disc includes at least a portion of a file allocation statement; moreover, the embodiment provides that re-reading at the locus occurs within about one second of reading at the locus, or within about ten milliseconds of reading at the locus, or within about one millisecond of reading at the locus.

Another illustrative embodiment of this method further provides the optical storage capable disc with a light-sensitive compound, wherein the light-sensitive compound has an emission wavelength of less than about 848 nm.

Further to the embodiment, re-reading at a certain locus includes reading a signal from the light-sensitive compound in the optical path of the locus and an optical detector, wherein the light-sensitive compound has an emission wavelength detectable by a detector in an optical reader.

Another illustrative embodiment of the method provides a light-sensitive compound that absorbs light that, in the absence of the light-sensitive compound, would be detected by a detector in an optical reader. Furthermore, a light emission from the light-sensitive compound provides at least a portion of the data obtained.

An illustrative embodiment of this method provides a light-sensitive compound in or on the optical disc that is excitable by the light emitted by a light source in the optical reader, wherein the light-sensitive compound has an emission wavelength from about 770 nm to about 830 nm or an emission wavelength of about 780 nm. or an emission wavelength from about 630 nm to about 650 nm, or an emission wavelength of about 530 nm, or an emission wavelength in the near infrared range. Another such embodiment provides is a luminescent or phosphorescent compound, wherein the light-sensitive compound has an emission wavelength of about 780 nm, or about 530 nm, or both.

Alternatively, an embodiment of the method utilizes a cyanine compound, in particular including indodicarbocyanines, benzindodicarbocyanines and hybrids thereof.

Various other illustrative embodiments provide an optical recording disc selected from among CD, CD-Audio, CD-ROM, CD-G, CD-i, CD-MO, CD-R, CD-RW, DVD, DVD-5, DVD-9, DVD-10, DVD-18, DVD-ROM or any optical recording suitable disc.

As another illustrative embodiment, the method of authenticating stored information in or on optical discs which include data structure, comprises reading the storage capable optical discs at a locus to obtain a first set of usable data from the data structure at the locus; and re-reading the optical storage disc at the locus to obtain a second set of usable data, wherein the second set of usable data is different from the first set of usable data regardless of the data structure of the optical storage disc at the locus.

The method embodiment illustrates reading or re-reading the optical discs at the locus to obtain data at the locus. In this context, as another illustrative embodiment, the method involves reading or re-reading the optical storage disc at the locus to obtain data at the locus in the form of a data byte.

As another illustrative embodiment, reading or re-reading the stored information on or in optical discs at the locus to obtain data at the locus also involves reading or re-reading the optical discs at the locus to obtain a data frame.

Another illustrative embodiment of the method provides reading or re-reading the stored information in or on optical discs at the locus to obtain data at the locus. Moreover, the embodiment of the method provides reading or re-reading the stored information in or on the optical discs at the locus to obtain a data block at the locus.

As another illustrative embodiment, the method of reading or re-reading the optical discs at the locus to obtain data at the locus comprises reading or re-reading the optical discs at the locus to obtain a data sector.

As another illustrative embodiment, the method further provides re-reading the optical discs at a second locus.

Another illustrative embodiment involves a method wherein the first set of data produces a signal that is inadequate to provide for an intended use of data stored on or in the optical disc, and wherein the second set of usable data produces a signal that is adequate to provide for an intended use of data stored on the optical disc.

As an illustrative embodiment, the second set of usable data comprises at least a portion of a file allocation statement, wherein re-reading at the locus occurs within about one second of reading at the locus; or re-reading at the locus occurs within about ten milliseconds of reading at the locus, or re-reading at the locus occurs within about one millisecond of reading at the locus.

In this context, the illustrative embodiment provides the optical storage disc with a light-sensitive compound; furthermore, the embodiment involves re-reading at the locus by reading a signal from the light-sensitive compound.

A further illustrative embodiment of the method provides a light-sensitive compound in the optical path of the locus and an optical detector.

According to another illustrative embodiment, the light-sensitive compound has an emission wavelength at a wavelength detectable by an optical reader, wherein the light-sensitive compound absorbs light that, in the absence of the light-sensitive compound, would be detected by a reader, and/or wherein a light emission from the compound provides at least a portion of the second set of usable data.

An illustrative embodiment of the authentication method includes a light-sensitive compound excitable by light emitted by the optical reader, wherein the light-sensitive compound has an emission wavelength from about 770 nm to about 830 nm, or an emission wavelength of about 780 nm, or an emission wavelength from about 630 nm to about 650 nm, or an emission wavelength of about 530 nm. Furthermore, the embodiment provides the light-sensitive compound having an emission wavelength wherein the compound is excitable at a wavelength of about 780 nm or about 530 nm or both.

In addition, the illustrative embodiment provides a light-sensitive, cyanine compound, wherein the compound is selected from indodicarbocyanines, benzindodicarbocyanines and hybrids thereof.

Another illustrative embodiment provides an optical recording disc selected from'CD, CD-Audio, CD-ROM, CD-G, CD-i, CD-MO, CD-R, CD-RW, DVD, DVD-5, DVD-9, DVD-10, DVD-18, DVD-ROM or any optical recording disc.

Another illustrative embodiment provides an authentication method wherein the light-sensitive compound is an indodicarbocyanine.

Another illustrative embodiment provides an authentication method wherein the light-sensitive compound is an benzindodicarbocyanine.

Another illustrative embodiment provides an authentication method wherein the light-sensitive compound is a hybrid of an indodicarbocyanine and a benzindodicarbocyanine.

A particularly illustrative embodiment provides a method of authenticating stored information in or on an optical disc having a first plane including data and a second plane having a light-sensitive compound, wherein the method comprises reading data from the first plane on the optical storage disc; exciting the light-sensitive compound in a second plane on the optical disc and reading data from the second plane of the optical disc.

A further illustrative embodiment of the aforementioned method is capable of instructing a reader to alter a focal length of a laser.

Another embodiment of the method of treating an storage optical capable disc comprises recording a first set of usable data on an optical disc by applying a light-sensitive compound to the optical disc at a location on the optical disc so that the light-sensitive compound cooperates with the first set of usable data and selectively activating at least a portion of the light-sensitive compound, wherein, in the activated state, the light-sensitive compound allows reading of the first set of data and the light-sensitive compound is responsive to excitation so as to produce a second set of usable data that is different from the first set of usable data.

More specifically, the illustrative embodiment provides a method wherein the light-sensitive compound is activated b-v cross-linking. Said cross-linking can be achieved by laser activation.

Another illustrative access embodiment provides a method for dissuading the illicit copying of data stored on an optical disc comprising a series of optical deformations representative of data. The prohibiting or controlling method introduces one or more physical change into or on said optical disc at selected positions on or within said optical disc. The selected positions are mapped with respect to said optical deformations, wherein said physical changes do not alter the physical structure of said optical deformations. This method then incorporates into the data stored on said optical disc a program instruction set for detecting said physical changes in said optical disc at said mapped positions and for effectuating read of said data stored on said optical disc when said physical changes are determined to be present at said select positions on or within said optical disc.

Further to the above illustrative embodiment, said physical change comprises a light-sensitive compound placed on or in said optical disc wherein the light-sensitive compound is a light absorptive compound, or a light emissive compound, which may be a phosphorescent compound.

An illustrative embodiment of the access prohibitive or controlling method provides that the light-sensitive compound has an emission wavelength at a wavelength detectable by a detector in an optical reader; or alternatively, the light-sensitive compound absorbs light that, in the absence of the light-sensitive compound, would be detected by a detector in an optical reader; wherein the light-sensitive compound is cyanine compound such that the light-sensitive compound is selected from indodicarbocyanines, benzindodicarbocyanines, or hybrids thereof.

Another illustrative embodiment provides a method for dissuading the illicit copying of information or data stored on an optical disc in an optical data structure, by introducing into or on said optical disc a material capable of altering the data read of said optical data structure between a first data state represented by said optical data structure and a second data state not true to said optical data structure and by incorporating into the data stored on said optical disc a program instruction set for detecting said first data state and said second data state and for effectuating reading of said data stored on said optical disc when said optical disc displays said first data state and said second data state upon data read of said optical disc.

The above embodiment of the access prohibiting or controlling method provides material comprising a light-sensitive compound wherein the light-sensitive compound is a light absorptive compound or a light emissive compound. More particularly, the light-sensitive compound may be a phosphorescent compound.

According to an illustrative embodiment of the access controlling method, the aforementioned light-sensitive compound has an emission wavelength detectable by a detector in an optical reader.

According to another illustrative embodiment, the light-sensitive compound absorbs light that, in the absence of the light-sensitive compound, would be detected by a detector in an optical reader. The light-sensitive compound may be a cyanine compound which may be selected from indodicarbocyanines, benzindodicarbocyanines, or hybrids thereof.

As an illustrative embodiment for the method dissuading the illicit copying of data stored on an optical disc in an optical data structure representing a series of bits. The method entails first reading the optical disc at a locus to obtain data true to the series of bits represented by the optical data structure at such locus; then re-reading the optical disc at the locus to determine if the data obtained varies by one or more bits in the series of bits represented by the optical data structure at such locus; and thus dissuading copying of the optical storage disc if the data obtained in the re-reading differs from the data in the initial reading.

An illustrative embodiment provides a computer-readable optical disc storing data in whole or in part in an optical data structure representing a series of bits. Said computer-readable optical disc contains instruction for detecting at a locus of the disc data true to the series of bits represented by said optical data structure detecting at said locus of said optical storage disc data varying by one or more bits in the series of bits represented by the optical data structure at such locus; permitting reading of said optical storage capable disc when the data obtained in the re-read differs from the data of the initial read.

Another illustrative embodiment provides an article of manufacturing comprising a computer usable disc having computer readable program code embodied in an optical data structure, where said article of manufacture contains one or more sites of optical disuniformity that are not embodied in said optical data structure, said sites of optical disuniformity hampering the normal copying function of a computer. Moreover, said computer readable program code comprises computer readable program code for causing said computer to read said optical data structure, or portion thereof, only when said sites of optical disuniformity are present in or on said computer usable disc.

Further embodiments of the article of manufacture involve sites of optical disuniformity comprising a light-sensitive compound, wherein the light-sensitive compound is a light absorptive compound, or a light emissive compound, or a phosphorescent compound, or the light-sensitive compound has an emission wavelength detectable by a detector in an optical reader.

Another embodiment provides an article of manufacture wherein the light-sensitive compound absorbs light that, in the absence of the light-sensitive compound, would be detected by a detector in an optical reader. Further, provides an article of manufacture wherein the light-sensitive compound is cyanine compound selected from indodicarbocyanines, benzoindodicarbocyanines, or hybrids thereof.

According to an illustrative embodiment, an optical disc comprises a substrate having one or more information pits and lands thereon readable as digital data bits by an optical reader, and a light-emissive compound positioned over, under, in, or on, one or more of said information pits and lands. Said light-emissive compound is selectively positioned with respect to the information pits and lands so as to affect the bit read of said optical reader when said compound is emitting light, but not affecting the bit read of said optical reader when said compound is not emitting light. Said light-emissive compound is excited by exposure to an input signal and is spontaneously convertible to being light-non-emissive after a period of time wherein the light-emissive compound has an emission wavelength at a wavelength detectable by the reader; light emission from the light-emissive compound provides at least a portion of the data obtained when the disc is read wherein the light-emissive compound is excitable by light emitted by a light source of the reader, wherein the disc is selected from the group consisting of CD, CD-Audio, CD-ROM, CD-G, CD-i, CD-MO, CD-R, CD-RW, DVD, DVD-5, DVD-9, DVD-10, DVD-18, DVD-ROM and any optical disk.

Another illustrative embodiment of an optical disc comprises: a substrate; a data track disposed on the substrate, the data track including a first set of usable data; and a light-sensitive compound disposed on at least a portion of the disk and cooperating with at least a portion of the data track, the light-sensitive compound being excitable with a suitable stimulus to produce a second set of usable data that is different from the first set of usable data regardless of the first set of usable data in the data track. At least a portion of the light-sensitive compound is adapted to emit a wavelength of less than about 848 nm.

The data track of the disc is injection molded, and/or formed via a recording dye.

At least a portion of the light-sensitive compound is active, or for example, phosphorescent or fluorescent.

The optical disc has at least a portion of the light-sensitive compound excitable by a light source emitting light at a wavelength between about 770 and about 830 nm.

The optical disc has at least a portion of the light-sensitive compound excitable by a light source emitting light at a wavelength between about 630 and about 650 nm.

The optical disc has the light-sensitive compound excitable by both a light source emitting light at a wavelength between about 780 nm and by a light source emitting at about 530 nm.

The optical disc has at least a portion of the light-sensitive compound adapted to emit at 780 nm.

The optical disc has at least a portion of the light-sensitive compound adapted to emit at 530 nm.

The optical disc has at least a portion of the light-sensitive compound adapted to emit at both about 780 nm and about 530 nm.

The optical disc has the light-sensitive compound comprises a cyanine compound.

The optical disc has, in this context, the light-sensitive compound comprises indodicarbocyanines,

The light-sensitive compound is benzindodicarbocyanines, or a hybrid of indodicarbocyanines and benzoindodicarbocyanines.

A portion of the light-sensitive compound is adapted to be selectively activated.

The light-sensitive compound is less than about 160 nm in thickness.

The light-sensitive compound is activated by cross-linking.

The light-sensitive compound is activated by laser activation.

The light-sensitive compound is activated to provide at least a portion of a file allocation statement.

The data track includes instructions to re-read a locus on the disc.

Activated light-sensitive compound is disposed under at least a portion of the locus.

Activated light-sensitive compound is disposed over at least a portion of the locus.

The activated light-sensitive compound is a delayed luminescent or phosphorescent compound.

The activated light-sensitive compound is interpretable by a reader to provide a response different from that provided by the data track.

The data track includes instructions to continue accessing data on the disk based on the first and second sets of usable data being different.

The light-sensitive compound is disposed on the disk by spin coating.

The light-sensitive compound is less than about 120 nm in thickness.

The light-sensitive compound is less than about 10 nm in thickness.

The light-sensitive compound is less than about 1 nm in thickness.

The optical recording disc comprises a CD or DVD.

### BRIEF DESCRIPTION OF THE DRAWINGS

The invention will now be described, by way of example, with reference to the accompanying drawings, in which:

FIG. 1 is a schematic illustration of one type of optical reader that may be used with an embodiment of the present invention.

FIG. 2 is an enlarged cross-sectional illustration of an optically readable disc including recorded data.

FIG. 3 is a cross-sectional illustration of an optically readable disc including recorded data and a representation of the binary data that is read when the disc is sampled.

FIG. 4 is a cross-sectional illustration of an optically readable disc including recorded data and a representation of the binary data that is detected when the disc is sampled.

FIG. 5 is a cross-sectional illustration of the optical disc of FIG. 4 including a representation of the binary data that is read when the disc is re-read.

FIG. 6 is a cross-sectional illustration of an optical disc including a representation of binary data that is detected when the disc is re-read.

### DETAILED DESCRIPTION OF THE INVENTION

The present invention is directed to protecting optical storage capable disc from being reproduced or copied. More particularly, the invention provides for the altering of the digital data output from a section of the disc in a manner that allows the data to be read without requiring alterations to the hardware, firmware or software used in optical disc readers while preventing reproduction of the information storage disc. This may be accomplished by employing a light-sensitive compound on the disc that reacts upon excitation from the light within a conventional optical reader in a manner to selectively alter data read by the reader.

“Optical Storage Disc” refers to disc capable of storing. digital data that may be read by an optical reader.

“Light Sensitive Compound” refers to a compound that responds to irradiation with light.

“Light Absorptive Compound” refers to a compound that absorbs light in response to excitation.

“Light Emissive Compound” refers to a compound that emits light in response to excitation.

“Re-read” refers to re-sampling a portion of the data recorded on an optical disc after it has been initially read.

“Fluorescent Compound” refers to a compound that radiates light in response to excitation by electromagnetic radiation.

“Phosphorescent Compound” refers to a compound that emits light in response to excitation by electromagnetic radiation wherein the emission is delayed from the time of excitation.

“Recording Dye” refers to a chemical compound that may be used with an optical recording disc to record digital data on the disc.

“Security Dye” refers to a compound that may provide or alter a signal to protect the data on an optical storage disc such as a disc.

“Active Light-Sensitive Compound” refers to an active form of a light-sensitive compound, as some light-sensitive compounds may exist in both active and inactive states.

“Active Security Dye” refers to the active form of a security dye, as some security dyes may exist in both active and inactive states.

“Activate” refers to transforming a compound from an inactive to an active state.

“Non-Destructive Security Dye” refers to a security dye that does not render optical disc permanently unreadable.

“Reader” refers to any device capable of detecting data that has been recorded on an optical disc.

Copy protection schemes that are available today typically require changes to the hardware that is used to read, and potentially copy, the disc, or these schemes require the use of data encryption that may be broken by those who are determined to do so. The present invention may provide a technique that requires neither encryption nor hardware changes but may incorporate a physical change in or on the disc itself. The invention may provide for a first data set when the disc is sampled by a reader and then may provide for an alternative data set when the disc is re-read by the reader.

In one embodiment of the invention, a specific locus on an optical storage capable disc is read, and the same locus is re-read again. Upon re-reading, the data that is read from the locus is different from that of the initial reading. This may be accomplished by incorporating a compound into or onto the disc. Upon exposure to light of a wavelength, the compound may provide no immediate response. However, upon re-reading by the reader, which occurs later in time, the compound emits light at an intensity and wavelength sufficient to alter the data that is read from the disc. As would become apparent, the data may be blocked upon re-reading.

In another embodiment, an optical disk that includes a substrate with a data track disposed on the substrate includes a non-destructive light-sensitive compound that has been disposed on at least a portion of the disk.

In another embodiment of the invention, a light-sensitive compound is applied to an optical storage capable disc on which data has been or will be recorded. At least one portion of the light-sensitive compound may then be selectively activated so that the light-sensitive compound provides delayed light emission or absorption in response to excitation with a light source.

In another embodiment, a method of authenticating optical storage disc is provided wherein data is sampled from a first track of an optical disc with the first track being located in a first plane, and at the same time, exciting a light-sensitive compound that resides in a different, second plane on the optical disc. The output produced from the light-sensitive compound in the second plane is then sampled from the optical disc.

In another embodiment, a data track containing readable data is re-read and at least a portion of the data is predictably altered upon re-reading.

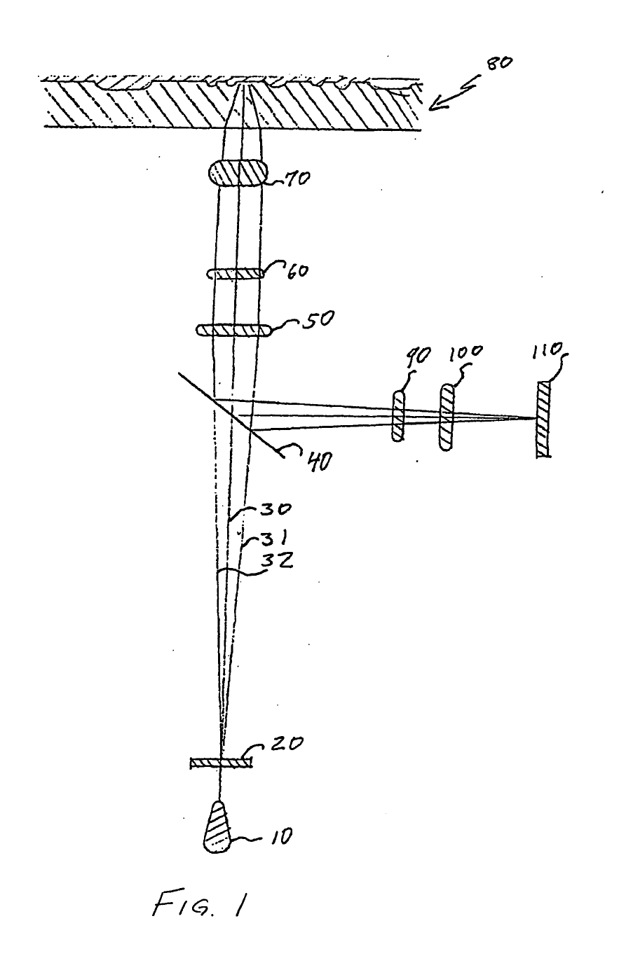

The invention may be useable with conventional optical disc. For example, a DVD disk incorporating the invention may provide protection when being read by an “off the shelf” DVD player. In addition, the invention may be incorporated into mass production techniques that are currently used to produce, for example, CDs and DVDs, and may not require changes to production line plant and equipment. FIG. 1 provides a schematic representation of a conventional CD reader that may be used in conjunction with the invention.

Referring to FIG. 1, a light source 10, typically a laser diode, emits light of a specific wavelength, for example, 780 nm. The light passes through defraction grating 20 where it splits into a primary beam 30 and secondary beams 31 and 32. Each of these beams then passes through polarizing beam splitter 40 which polarizes them by 90 degrees. Each of these beams then passes through collimating lens 50 and then through ¼ waveplate 60. ¼ waveplate 60 converts the light into circularly polarized light. The polarized, collimated light beams then pass through objective lens 70 and are focused onto optical disk 80, such as a CD, that is spinning at a variable rate to provide for constant velocity of the track, regardless of the laser's position on the disk. Any light that is reflected back from the disk (see description below) passes back through the objective lens 70 and through the ¼ waveplate 60 which further polarizes the light so that it is now polarized perpendicularly in comparison to the polarization of the first light beam prior to its initial passage through the % waveplate 60. The reflected beam then passes back through the collimating lens 50 and because of its change in polarization is now reflected off of beam splitter 40 rather than passing through beam splitter 40. The reflected beam is then focused through concave lens 90 and further through cylindrical lens 100, which aids in the tracking of the light beam along the data track. Finally, the reflected light beam impinges upon photon detector 110 where the signal can be detected and processed.

Although one type of optical reader is described, the present invention is not limited in this respect and other suitable optical readers may be employed in conjunction with the invention. The above description, therefore, is merely illustrative of a typical optical reader. Those skilled in the art will recognize various alternatives for an optical detector, whether embodying some or all of the elements described above, that may be employed with the present invention.

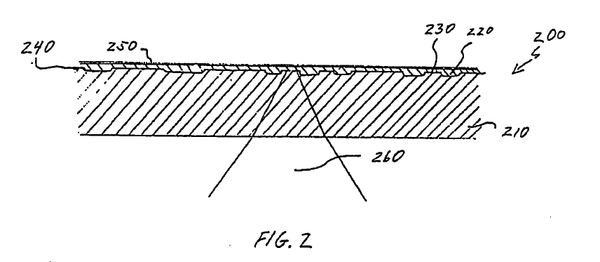

An enlarged view of the CD is illustrated in FIG. 2, which shows a cross-sectional view (not to scale) of a track on the CD. The CD substrate 210 is typically made from a polymer such as polycarbonate, however, other suitable materials may be used. Data is recorded on the CD by forming a series of pits 220 and lands 230 in the substrate of the disc. Pits and lands may be formed using any suitable technique including injection molding of the features themselves or, alternatively, using a recording compound and a writing laser. If a recording compound is used, data may be written to the disc using a laser that is designed to heat the recording compound to a point where adjacent polymer material is deformed to form the pits and lands. Typically, for an audio CD, each pit is about ½ micron wide and anywhere from about 0.8 to 3.5 microns long. However, it should be appreciated that the present invention is not limited in this respect and other methods of recording and/or sharing data on the CD may be employed.

The pits and lands are typically coated with a reflective layer 240, of, for example, aluminum, which is then coated by a protective layer 235, typically acrylic. If desired, the acrylic layer may be covered by a label, 250. In operation, the light beam 30, typically at a wavelength of 780 nm, passes through the surface of the polycarbonate substrate 210 where it becomes more sharply focused due to the high refractive index of the polycarbonate. The beam is focused on the reflective surface 240 where it is highly reflected by the lands 230, and less directly reflected, or scattered, by pits 220. The pits are typically formed at a height of about ‘A of the wavelength of the light passing through the polycarbonate. Thus, light that is reflected from a land travels about ½ wavelength farther than light that is reflected from a pit, resulting in light reflected from a pit being out of phase with light reflected from a land. The two waves will therefore cancel each other, resulting in no light being reflected back to the detector.

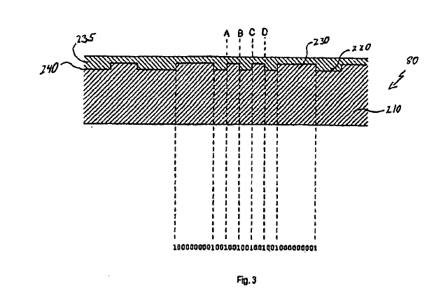

FIG. 3 illustrates schematically one method of transforming a light beam reflected off of a CD into digital information. By setting a threshold level of reflectance, transitions between pits and lands may be detected at the point where the signal generated from the reflectance crosses a threshold level. Whenever the threshold level is crossed, i.e., a transition between a pit and a land or between a land and a pit is detected, a binary code of 1 is read. At all other intervals, a 0 is detected. Thus, both pits and lands may actually represent a series of 0's; it is the transition that represents a 1. In this manner, binary information may be read from the disk.

As may be apparent to those skilled in the art, the data on a disk may be transformed using an eight to fourteen modulation (EFM) convention. EFM provides a process whereby 1′s need not be written consecutively, as this would require extremely small pits or lands with frequent transitions that might result in numerous errors. In addition, EFM specifies that at least two and no more than 10 0's appear between any pair of 1′s. In addition, three merging bits are placed between each fourteen bit set to help further minimize errors. After detection, each fourteen bit piece of data is converted into an eight bit binary word. The fourteen bit process that is physically recorded onto the optical disc may contain no more than ten and no fewer than two 0's between each pair of 1's, but can represent any eight bit word. Although an EFM protocol has been described, the present invention is not limited in this respect and other protocols may be implemented. In addition, no such protocol need be employed. Thus, the above-described EFM is merely illustrative of conventional manipulation of data combined on a CD.

FIG. 3 shows how the raw bit data may be read from a CD track as it passes under the light source. For example, referring again to FIG. 3, transition points may be seen at points A, B, C and D. Each of these points corresponds to a transition in the disc between a pit and a land or a land and a pit. At each of these transition points, the signal generated from the reflected laser crosses the threshold and a 1 is read at each of these transition points. At non-transition points, a series of 0's is read.

The method and apparatus of the present invention may provide producers and distributors of digital data with a technique that aids in the prevention of reproducing, for example, software, audio and video optical disc. Some of the formats with which the invention may be useful include, but are not limited to, CD Audio, CD-ROM, CD-G, CD-i, CDMO, CD-R, CD-RW, DVD, DVD-5, DVD-9, DVD-10, DVD-18 and DVD-ROM.

In one embodiment, the invention may provide copy protection by changing the output from an optical disc upon re-reading of a locus on the disc. The location that is re-read may be of any size or type and may include, for example, a single bit, a byte, a frame, a block, a sector or any other selection that is recorded or will be recorded on the disc. In addition, any number of different locations may provide a change in output upon re-reading.

Many conventional optical disc readers such as CD and DVD readers may be capable of oversampling a particular locus on the optical disc to reduce the likelihood of playback errors. Oversampling may occur imdisctely after an initial sampling or may be delayed. Software written on the optical disc may direct the reader to resample a particular set of data one or more times, or a reader may be pre-programmed to resample the disc a number of times without any additional input from software on the disc. For example, one way in that a CD player may resample data is by oversampling an audio disk several times in order to reduce errors and ensure adequate reproduction. A data set on a CD or DVD may be oversampled any number of times, for example, 4× or 8×, and the readings may be compared so that errors maybe eliminated or minimized. In one embodiment, the invention may incorporate such oversampling.

The output at a particular locus may be changed by including an additional compound in or on the disc. For example, on an initial reading, the compound may have little or no effect on passing light and therefore underlying data is read and interpreted as originally recorded. However, the passing light may influence the compound and change its properties so that upon re-reading, the signal that is received by the detector is different from that which was received upon initial sampling. The compound may be a light sensitive compound. For instance, the added compound in the disc may become reflective within a timeframe that provides for reflectance of the light beam upon resampling. Alternatively, a compound may provide for delayed emission or absorbance of light and therefore may be used to alter the signal either positively or negatively.

In one example, data recorded on an optical disc instructs the optical reader to reread a particular locus on the disc. For example, the reader may be instructed to re-read a sector on the disc. The disc may contain areas that include a light sensitive compound, such as a fluorescent or phosphorescent compound. This light-sensitive compound may be chosen so that it is excited by a wavelength that is typically used by a reader on which the particular disc is played. For example, in the case of a CD reader, the light-sensitive compound may be chosen to absorb at about 780 nm. The light-sensitive compound may be placed anywhere in or on the disc and in one version may be strategically placed in the light path between the data recorded on the optical disc and the detector that is used to read the reflected light off of the disc. If, upon re-reading, a reading from the light-sensitive compound is detected, access to the data on the disc may be provided. If the response upon re-reading is the same as upon initial sampling, indicating absence of the light-sensitive compound, further access may be denied.

Protection may be also provided by using a light-sensitive compound to record data at a particular locus required for the optical disc to be operable. The light-sensitive compound may be placed in a different plane in or on the disc, so that in order to be optimally read, the focal length of the optical system should be adjusted. Software included on the disk may direct the optical reader to alter its focal length appropriately, however, when an attempt is made to reproduce the disc, the copyist may be unable to reproduce the required data on discs that do not include properly placed light-sensitive compound.

The light-sensitive compound may be placed in the disc as close to the recorded data as possible. This may provide, for example, a more precise focusing of the light beam in the area of the light-sensitive compound as the substrate material of which the disc is composed may serve as a lens to further concentrate the light beam at the point where the data has been recorded. Thus, if the light beam focuses on the appropriate plane in which the recorded data lies, it may not be fully focused on the light-sensitive compound that lies in a plane that is a distance from the recorded data. To minimize this difference in focal length, the light-sensitive compound layer may be placed directly over the recorded data. Upon a first pass of the light beam over the locus of the disc containing the light-sensitive compound, the compound may absorb some of the light, however, some of the light may pass through the compound striking the recorded data on a track in the disc, and reflecting back up through the light-sensitive compound to a detector where the data may be read, as it would be in the absence of the light-sensitive compound. However, if the reader has been instructed to re-read this particular locus, the reader will return to the same area on the disc in order to re-read the same set of data. By this time however, the light-sensitive compound may be emitting or reflecting or absorbing at a wavelength detected by the reader, and the signal produced from the detector may differ from that produced upon initial sampling, as areas that were initially of low reflectance, e.g., pits in the recording disc, are now read as reflectant due to the emission from the light-sensitive compound. If the emission from the light-sensitive compound is sufficient to provide a signal above a threshold, the data output will be varied from that which was originally read upon initial sampling. Thus, at the same point on the track, the recorded data may be read differently, though predictably, depending on whether the data is being initially read or re-read.

Protection may also be implemented by changing the wavelength of light from a reader. For example, the recorded data on the disc may include instructions for the reader to use a different light source having a different wavelength to sample a particular locus on the disc. If the proper light-sensitive compound is present at the proper location, it will provide a detectable signal in response to being irradiated with light of the different wavelength. In turn, this may allow for continued access to the disc. If there is no response at the different wavelength, then access may be denied.

Delayed fluorescent compounds or phosphorescent compounds, emitting at a detectable wavelength after a specific amount of time, may be used in combination with an instruction set recorded on the disc that instructs the reader to re-read a specific locus on the disc after a time delay approximately equal to the amount of time required for the light-sensitive compound to fluoresce. For example, if a light-sensitive compound exhibits a peak fluorescence 1 millisecond after excitation by the light source, the disc may include instructions to direct the reader to re-read the particular area of the disc after a 1 millisecond time period. If, at the 1 millisecond time period, the expected fluorescence signal is detected, the reader is instructed to continue reading the recorded data off of the disc. If the expected fluorescence is not detected, access to the data on the disk may be denied. In this manner, a disc that does not include the proper compound in the proper location may not provide usable data to someone trying to access the data on the disc. Therefore, if an attempt is made to copy the optical disc, for example, by bit to bit copying, much of the data that is recorded on the disc may be successfully transferred, however the light-sensitive compound may not be copied as it may only be activated upon re-reading and in a typical bit-to-bit copying utility, bits are systematically copied as they are read. Thus, the copy will be inoperable.

Furthermore, if the light-sensitive compound is, in fact, detected during the copying procedure, it may not be possible to reproduce the signal provided by the light-sensitive compound at the same location on the optical disc that holds the originally recorded data, as a single locus on a track cannot simultaneously hold two different data sets. Therefore, when an attempt is made to operate a copy of the disc, the reader will be instructed to initially sample a specific locus on the disc and then re-read the locus looking for a different response. The unauthorized copy, however, may be able to provide only one of the two required responses as the copying system may be capable only of writing a single data set to the specific locus on the disc. Even if the data represented by the light-sensitive compound is copied, it may not be copied to the correct location and thus the copy may remain inoperable.

In other embodiments, any combination of sampling and re-reading of one or more areas of the disc may be employed. For example, the reader may be directed to resample a location on the disc and then wait a sufficient time for fluorescence to degrade to non-detectable levels and then take a sampling of the location and detect the signal received from the underlying data.

In another embodiment, the reader itself may be programmed or designed to resample and analyze specific, areas on an optical disc prior to proceeding with reading the disc. In this manner, among others, it may be possible to copy protect the optically readable disc without including reading instructions on the disc itself.

In addition to using fluorescent light-sensitive compounds, other light-sensitive compounds, for example, dyes, pigments, phosphorescent compounds and light absorptive compounds may also be employed. For example, light absorptive compounds may be used to selectively absorb light that may be emitted by a reader or reflected off of particular areas of the disc. In this manner, the invention may allow a signal from a specific locus on a disc to be altered from one giving a reading above a threshold to one that reads below a threshold. Thus, the invention may be used to supply a positive signal where previously a negative one was present or alternatively, to supply a negative signal where previously a positive one was present. Various combinations of compounds may be used on the same or different disc to produce both positive and negative changes in signal upon re-reading.

Light-sensitive compounds may be placed on the optical disc in a number of ways. For example, a compound may be specifically placed in the optical path between a data set that has been recorded on the disc and the optical detector. It may be appropriate to place a light-sensitive compound over a larger area of the disc than is necessary to provide a signal change. As it may be preferable for the light-sensitive compound to be active only upon rereading, extraneous placement of the compound may not interfere with the initial reading of the recorded data. Furthermore, the light-sensitive compound may be distributed on the disc in an inactive form and specific areas containing the compound may be activated later in time. For example, an inactive form of a delayed fluorescence compound may be spin coated across a portion of, or all of, the disc. After the inactive form of the fluorescent compound has coated a portion of the disc, it may be selectively activated at one or more locations to transform the compound into an active form.

In one embodiment, specific areas of the fluorescent compound may be activated by cross-linking. For some light-sensitive compounds, a laser may catalyze cross-linking of the inactive form of the light-sensitive compound and thus selectively transform it into an active form. This technique may allow for localized compound activation and may provide for data alteration on a small scale, such as a single bit. This selective activation of various portions of the light-sensitive compound may be performed in a manner similar to that used to write data to a CD-R disc. In fact, the same device may be used to write data to a disc as well as to selectively activate portions of the light-sensitive compound. This may be done, for example, by using a variable power writer, or alternatively, it may be done by placing the light-sensitive compound on the disc in a plane that provides a different focal point than that provided by the recording dye. In this latter method, the focal point of the writing laser may then be altered to either affect the recording dye or the light-sensitive compound. If the data track on a specific disc is transferred to the disc by a physical means, for example, by injection molding, the activation wavelength of the light-sensitive compound may be chosen without regard to recording dyes.

In another embodiment, the light-sensitive compounds may be chosen from those having an excitation wavelength at or about the same wavelength used by a reader. For example, if a CD reader uses a laser diode emitting light at a wavelength of about 770-830 nm, then the light-sensitive compound may be chosen from a group having excitation wavelengths in the same range. In another embodiment, the light-sensitive compound may be chosen from a group of compounds having excitation wavelengths at about 630-650 nm, a wavelength typically used in a DVD reader. In another embodiment, compounds may be chosen that possess dual excitation wavelengths at both about 780 nm and about 530 nm. If such a dual wavelength compound is used, a single compound composition may be employed for use with disc to be used with either a CD player or a DVD player. Such a compound composition may be either a mixture of different compounds or contain a single compound that exhibits multiple excitation wavelengths.

In another embodiment of this method, the compounds are chosen so that they emit at wavelengths that are the same or close to the same as the wavelengths that are detected by the readers. For example, for use with a CD, the light-sensitive compound may emit at about 780 nm and for use with a DVD, the light-sensitive compound may emit at a wavelength of about 650 nm. The chosen security dies may exhibit long term stability under typical optical disc storage conditions and the compounds may be light fast and non-reactive. In addition, compounds may be chosen based on compatibility with the polymer or other material that is used to produce the optical disc substrate. Light-sensitive compounds may be chosen from those that exhibit stability for the expected lifetime of the optical discs.

In one embodiment, the light-sensitive compounds are chosen from among suitable dyes, specifically, cyanine dyes. These cyanine dyes include, among others, indodicarbocyanines (INCY), benzindodicarbocyanines (BINCY), and hybrids that include both an INCY and a BINCY. Hybrids may be, for example, mixtures of two different dyes or, in another embodiment, compounds that include both INCY and BINCY moieties. In one embodiment, the light-sensitive compound is a ratiometric compound having a linked structure with excitation ranges at both the CD. and DVD ranges of about 530 and 780 nm. In a further embodiment, the dye is phosphorescent, having a time delay of about 10 milliseconds. Table 1 provides some of the dyes that may be useful with the invention.

TABLE 1

| Dye Name/No. | CD/DVD | Excitation λ | Emission λ |
|---|---|---|---|
| Alcian Blue | DVD | 630 nm | Absorbs |
| (Dye 73) | | | |
| Methyl Green | DVD | 630 nm | Absorbs |
| (Dye 79) | | | |
| Methylene Blue | DVD | 661 nm | Absorbs |
| (Dye 78) | | | |
| Indocyanine Green | CD | 775 nm | 818 nm |
| (Dye 77) | | | |
| Copper | CD | 795 nm | Absorbs |
| Phthalocyanine | | | |
| (Dye 75) | | | |
| IR 140 | CD | 823 nm | 838 nm |
| (Dye 53) | | (66 ps) | |
| IR-768 Perchlorate | CD | 760 nm | 786 nm |
| (Dye 54) | | | |
| IR 780 Iodide | CD | 780 nm | 804 nm |
| (Dye 55) | | | |
| IR 780 Perchlorate | CD | 780 nm | 804 nm |
| (Dye 56) | | | |
| IR 786 Iodide | CD | 775 nm | 797 nm |
| (Dye 57) | | | |
| IR 768 Perchlorate | CD | 770 nm | 796 nm |
| (Dye 58) | | | |
| IR 792 Perchlorate | CD | 792 nm | 822 nm |
| (Dye 59) | | | |
| 1,1′-dioctadecyl-3,3,3′,3′- | DVD | 645 nm | 665 nm |
| tetramethylindodicarbocyanine | | | |
| Perchlorate (Dye 231) | | | |
| 1,1′-dioctadecyl-3,3,3′,3′- | DVD | 748 nm | 780 nm |
| tetramethylindo tricarbocyanine | | | |
| Iodide (Dye 232) | | | |
| 1,1′,3,3,3′,3′-hexamethyl | DVD | 638 nm | 658 nm |
| indodicarbocyanine Iodide | | | |
| (Dye 233) | | | |
| DTP | CD | 800 nm | 848 nm |
| (Dye 239) | | (33 ps) | |
| HITC Iodide | CD | 742 nm | 774 nm |
| (Dye 240) | | (1.2 ns) | |
| IR P302 | CD | 740 nm | 781 nm |
| (Dye 242) | | | |
| DTTC Iodide | CD | 755 nm | 788 nm |
| (Dye 245) | | | |
| DOTC Iodide | DVD | 690 nm | 718 nm |
| (Dye 246) | | | |
| IR-125 | CD | 790 nm | 813 nm |
| (Dye 247) | | | |
| IR 144 | CD | 750 nm | 834 nm |
| (Dye 248) | | | |

Light-sensitive compounds may be chosen from any compound or combination of compounds that serve to change the output signal from the disc upon re-reading. These compounds include delayed emission compounds, delayed absorbance compounds and other light sensitive compounds. For example, a layer in the disc that becomes reflective upon rereading may also be useful in predictably altering the output of the disc.

Light-sensitive compounds may be placed on the optical disc in various thicknesses dependent upon the application. For example, if a phosphorescent compound is applied by a spin coating process, it may be dissolved in ethyl lactate and the compound may overcoat the entire disk. The thickness of the compound layer may be controlled by varying, among other factors, the rotational speed of the disc during this process. In one embodiment, the compound layer may be from 120 nm to less than 1 nm thick. The desired thickness of the compound layer that is applied may be a function of the absorption of the compound, the emission of the compound, the density of the compound and the structure of the disc, as well as the properties of the reader that is used to read the data off of the disc. In one embodiment, the compound may be applied at a thickness that is thin enough to allow transmission of light to adequately read the underlying data upon initial sampling while being dense enough to provide adequate fluorescence upon re-reading with the same reader.

A film thickness of from 50 to 160 nm has been found useful. It is preferred that the film thickness for a CD is in the range from about 70 nm to about 130 nm. While film thickness for a DVD is preferably in the range of from 50 nm to 160 nm, of course other suitable thicknesses may be employed.

In another embodiment, a 5 nm thick layer of a light-sensitive compound was spin coated onto a CD. At a laser diode wavelength of 780 nm, the absorption by the compound was about 61% and the delayed fluorescence of the compound was about 12%.

In addition to coating a light-sensitive compound onto the disc, the compound may be spotted at specific locations on the disc. Light-sensitive compound may be placed at any depth within or on the disc and is preferably at a position in the disc where the reader can adequately focus on the compound.

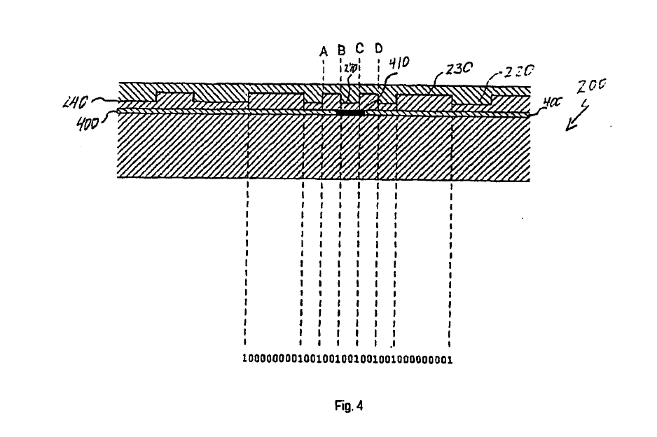

FIG. 4 illustrates an optical disc similar to that described in FIG. 3. The digital output from the disc upon initial sampling is shown and is the same as the output from the disc illustrated in FIG. 3. The optical disk 200 shown in cross-section in FIG. 4 contains an additional light-sensitive compound layer 400 (not present in FIG. 3) which is distributed through the disk in a position that is close to reflective layer 240. Although the security layer 400 is shown disposed within the substrate 210, the present invention is not limited in this respect and the light-sensitive compound may be dispersed in any other suitable location. Light-sensitive compound 400 may be cross-linked, for example, by laser catalysis, at specific locations to provide a delayed fluorescence compound at the specific locations. Referring to FIG. 4, the location of activated compound is shown at locus 410. The data recorded on the disk, represented by a series of pits 220 and lands 230, is identical to that shown in FIG. 3. In operation, a focused light source used to read the optical disk passes through light-sensitive compound layer 400 and a portion of the light is instantaneously reflected back through light-sensitive compound layer 400 so that the data output upon an initial reading is identical to that shown in FIG. 3.

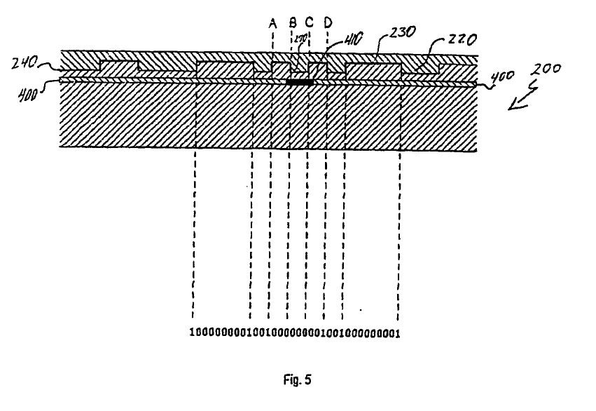

However, as is illustrated in FIG. 5, activated compound locus 410 is excited by the light and due to the compound's delayed fluorescence, emits light at a certain wavelength several milliseconds later, for example. Through instructions provided on the disk, the reader has been directed to re-read the same locus 410 on the disk shortly after its initial sampling. In one embodiment, as illustrated in FIG. 5, the reader re-reads locus 410 at about the time of the delayed fluorescence. The detector receives a different output than it does initially (as represented in FIG. 4) due to the light provided by the delayed fluorescence of activated lightsensitive compound locus 410. Light-sensitive compound locus 410 has been placed and activated to mask pit 270. Referring back to FIG. 3, showing a disk without light-sensitive compound 400, as the track passes through the focused light beam, transitions representing l's are detected at points A, B, C and D as the transition is made from pit to land or land to pit. The same response is received from the disc in the embodiment shown in FIG. 4, upon initial sampling. Referring now to FIG. 5, representing the response received upon re-reading, the light-sensitive compound at locus 410 is masking pit 270 and as the track passes through the light beam, a transition is still recognized at point A, but the transitions at points B and C are not detected because the emission of light from light-sensitive compound locus 410 blocks the transition and instead is read as a continuation of the land between points A and B. The signal generated across this span during re-reading does not cross threshold level, and the next transition to be detected is at point D. Thus, from points A to D the raw 14 bit data signal is read as 10010001001 prior to excitation of the light-sensitive compound at locus 410 (FIG. 4) and is read as 10000000001 upon re-reading when the light-sensitive compound at locus 410 has been excited by a previous pass of the laser (FIG. 5). The effective reflectance has been changed to simulate the removal of two transitions. In this manner, a different set of predictable data is read upon re-reading the same location that had been previously read by the same device. If the same location is re-read again after the compound emission has subsided, the initial reading of 10010001001 will be detected. The emission from the light-sensitive compound at locus 410 need not be as intense as that reflected back from a land but preferably is of adequate continuous intensity to prevent the signal from crossing the threshold.

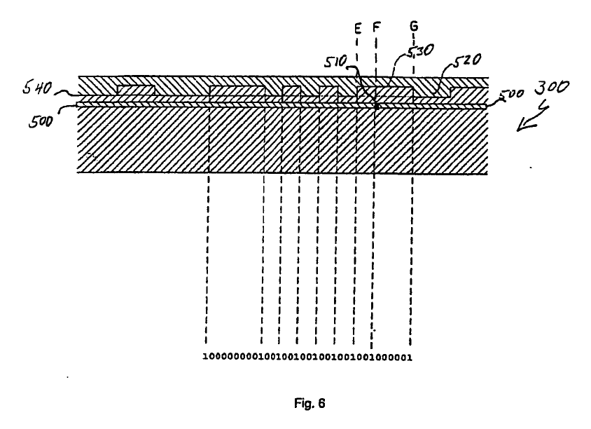

FIG. 6 illustrates an embodiment that uses a light absorbing compound to alter the data output from an optical disc. The data that has been recorded on disk 300 is identical to that shown in FIGS. 4 and 5. Inactive light absorbing compound has been disposed in a layer 500 across a portion of disk 300. Locus 510 has been activated to make the light absorbing compound active at point F. Upon initially reading the disk, the reader detects data that is equivalent to that detected in FIG. 4, described above. Upon re-reading the data however, locus 510 has been excited by the previous pass of the laser, and, upon re-reading, absorbs light that is reflected off of land 530, and this light is therefore not detected. Whereas initially the data read from the track between points E and G was detected as 1000000001, upon re-reading the light absorbing compound has altered the data so that over the same section it reads 1001000001. Thus, the use of a light absorbing compound has added a transition where previously there was none.

By incorporating light-sensitive compounds having specific time delay in light emission and/or excitation and/or absorption at various wavelengths, with instructions to re-read specific areas on the disc at time intervals based on the time delay, various copy prevention techniques may be formulated. Thus, any combination of sampling, re-reading and re-sampling of one or more locations on the disc may be used. In addition, any combination of light sensitive compounds may be used to further vary the copy protection techniques.

In accordance with certain embodiments of the present invention, various alterations, modifications and improvements will readily occur to those skilled in the art. Such alterations, modifications, and improvements are intended to be within the spirit and scope of the invention. The skilled artisan would know that the foregoing description is by way of example only, and is not intended to be limiting. The invention is limited only as to the scope of the following claims and the equivalents thereof.

What is claimed is:

1-139. (canceled)

140. An article of manufacture comprising a computer readable program code embodied in an optical data structure, wherein said article of manufacture contains one or more sites of optical disuniformity that are not embodied in said optical data structure and said sites of optical disuniformity hamper the normal copying function of a computer on which said optical data structure is read, and wherein said computer readable program code is operatively configured for causing said computer to read said optical data structure, or portion thereof, only when said sites of optical disuniformity are present in or on said optical data structure.

141. A computer-readable disc, comprising: stored data in whole or part in an optical data structure representing a series of bits, said computer-readable optical data storage capable disc containing instruction for:
(a) detecting at a locus of said optical storage disc data true to the series of bits represented by said optical data structure;
(b) detecting at said locus of said optical storage disc data varying by one or more bits in the series of bits represented by the optical data structure at such locus; and
(c) permitting read of said optical storage disc when the data obtained in (b) differs from the data in (a).

142. An article of manufacturing comprising: an optical disc comprising
a computer readable program code embodied in an optical data structure, and one or more sites of optical disuniformity therein that are not embodied in said optical data structure, said site or sites of optical disuniformity preventing the normal copying function of a computer, and
said computer readable program code causing said computer to read said optical data structure, or portion thereof, only when said site or sites of optical disuniformity are present in said optical disc.

143. The article of manufacture of claim 142 wherein said sites of optical disuniformity comprise a light-sensitive compound.

144. The article of manufacture of claim 143 wherein the light-sensitive compound is a light absorptive compound.

145. The article of manufacture of claim 143 wherein the light-sensitive compound is a light emissive compound.

146. The article of manufacture of claim 145 wherein the light-sensitive compound is a phosphorescent compound.

147. The article of manufacture of claim 143 wherein the light-sensitive compound has an emission wavelength at a wavelength detectable by a detector in an optical reader.

148. The article of manufacture of claim 143 wherein the light-sensitive compound absorbs light that, in the absence of the light-sensitive compound, would be detected by a detector in an optical reader.

149. The article of manufacture of claim 143 wherein the light-sensitive compound comprises a cyanine compound.

150. The article of manufacture of claim 143 wherein the light-sensitive compound comprises indodicarbocyanines, benzoindodicarbocyanines, and hybrids thereof.

151. The article of manufacture of claim 142 wherein the optical recording disc comprises CD, CD-Audio, CD-ROM, CD-G, CD-i, CD-MO, CD-R, CD-RW, DVD, DVD-5, DVD-9, DVD-10, DVD-18, DVD-ROM or any optical storage disc.

152. An optical disc comprising:
a substrate having one or more information pits and lands thereon readable as digital data bits by an optical reader, and a light-emissive compound positioned over, under, in, or on, one or more of said information pits and lands;
wherein said light-emissive compound is selectively positioned with respect to the information pits and lands so as to affect the bit read of said optical reader when said compound is emitting light, but not affecting the bit read of said optical reader when said compound is not emitting light, and
wherein said light-emissive compound is excited by exposure to an input signal and spontaneously convertible to being light-non-emissive after a period of time.

153. The disc of claim 152 wherein the light-emissive compound has an emission wavelength at a wavelength detectable by the reader.

154. The disc of claim 152 wherein light emission from the light-emissive compound provides at least a portion of the data obtained when the disc is read.

155. The disc of claim 152 wherein the light-emissive compound is excitable by light emitted by a light source of the reader.

156. The disc of claim 152 comprising a CD, CD-Audio, CD-ROM, CD-G, CD-i, CD-MO, CD-R, CD-RW, DVD, DVD-5, DVD-9, DVD-10, DVD-18, DVD-ROM or any optical disk.

157. An optical disc comprising:
a substrate;
a data track disposed on the substrate, the data track including a first set of usable data;
and a light-sensitive compound disposed on at least a portion of the disc and cooperating with at least a portion of the data track,
the light-sensitive compound being excitable with a suitable stimulus to produce a second set of usable data that is different from the first set of usable data regardless of the first set of usable data in the data track.

158. The disc of claim 157 wherein at least a portion of the light-sensitive compound is adapted to emit a wavelength of less than about 848 nm.

159. The disc of claim 157 wherein the data track is injection molded.

160. The disc of claim 157 wherein the data track is formed via a recording dye.

161. The disc of claim 157 wherein at least a portion of the light-sensitive compound is active.

162. The disc of claim 157 wherein at least a portion of the light-sensitive compound is phosphorescent.

163. The disc of claim 157 wherein at least a portion of the light-sensitive compound is fluorescent.

164. The disc of claim 157 wherein at least a portion of the light-sensitive compound is excitable by a light source emitting light at a wavelength between about 770 and about 830 nm.

165. The disc of claim 157 wherein at least a portion of the light-sensitive compound is excitable by a light source emitting light at a wavelength between about 630 and about 650 nm.

166. The disc of claim 157 wherein the light-sensitive compound is excitable by a light source emitting light at a wavelength between about 780 nm and by a light source emitting at about 530 nm.

167. The disc of claim 157 wherein at least a portion of the light-sensitive compound is adapted to emit at 780 nm.

168. The disc of claim 157 wherein at least a portion of the light-sensitive compound is adapted to emit at 530 nm.

169. The disc of claim 157 wherein at least a portion of the light-sensitive compound is adapted to emit at both about 780 nm and about 530 nm.

170. The disc of claim 157 wherein the light-sensitive compound comprises a cyanine compound.

171. The disc of claim 157 wherein the light-sensitive compound comprises indodicarbocyanines.

172. The disc of claim 157 wherein the light-sensitive compound comprises benzindodicarbocyanines.

173. The disc of claim 157 wherein the light-sensitive compound comprises a hybrid of indodicarbocyanines and benzoindodicarbocyanines.

174. The disc of claim 157 wherein a portion of the light-sensitive compound is adapted to be selectively activated.

175. The disc of claim 157 wherein the light-sensitive compound is less than about 160 nm in thickness.

176. The disc of claim 157 wherein the light-sensitive compound is activated by cross-linking.

177. The disc of claim 157 wherein the light-sensitive compound is activated by laser activation.

178. The disc of claim 157 wherein the light-sensitive compound is activated to provide at least a portion of a file allocation statement.

179. The disc of claim 157 wherein the data track includes instructions to re-read a locus on the disc.

180. The disc of 157 wherein activated light-sensitive compound is disposed under at least one portion of the locus.

181. The disc of claim 157 wherein the data track comprises instructions to continue accessing data on the disc based on the first and second sets of usable data being different.

182. The disc of claim 157 wherein the light-sensitive compound is disposed on the disk by spin coating.

183. The disc of claim 157 wherein the light-sensitive compound is less than about 120 nm in thickness.

184. The disc of claim 157 wherein the light-sensitive compound is less than about 10 nm in thickness.

185. The disc of claim 157 wherein the light-sensitive compound is less than about 1 nm in thickness.

186. The optical recording disc of claim 142 wherein the disc comprises a CD.

187. The optical recording disc of claim 142 wherein the disc comprises a DVD.
